(19) United States
(12) Patent Application Publication
(10) Pub. No.: US 2012/0162763 A1
(43) Pub. Date: Jun. 28, 2012

(54) IMAGE DISPLAY DEVICE

(75) Inventors: Hyeon-Ho SON, Gyeonggi-do (KR); Jin-Yeong Kim, Gyeonggi-do (KR); Hee-Young Chae, Gyeonggi-do (KR); Seung-Man Ryu, Gyeonggi-do (KR); Hee-Jin Im, Gyeonggi-do (KR); Ju-Hoon Jang, Seoul (KR)

(73) Assignee: LG Display Co., Ltd.

(21) Appl. No.: 13/299,484

(22) Filed: Nov. 18, 2011

(30) Foreign Application Priority Data
Dec. 28, 2010 (KR) 10-2010-0136911
May 24, 2011 (KR) 10-2011-0049115

(51) Int. Cl. G02B 27/26

(52) U.S. Cl. 359/463

(57) ABSTRACT

A image display device includes a display panel including a display area and a non-display area, wherein the display area includes left-eye horizontal pixel lines displaying a left-eye image and right-eye horizontal pixel lines displaying a right-eye image; a polarizing film disposed over the display panel, wherein the polarizing film linearly polarizes the left-eye image and the right-eye image; a patterned retarder disposed over the polarizing film and including left-eye retarders and right-eye retarders, wherein the left-eye retarders correspond to the left-eye horizontal pixel lines and change the linearly polarized left-eye image into left-circularly polarized image, and the right-eye retarders correspond to the right-eye horizontal pixel lines and change the linearly polarized image into right-circularly polarized image; and a lenticular lens film disposed over the polarizing film and including lenticular lenses, wherein the lenticular lenses correspond to the left-eye retarders and the right-eye retarders, respectively.

This application claims the benefit of Korean Patent Applications Nos. 10-2010-0136911 filed in Korea on Dec. 28, 2010 and No. 10-2011-0049115 filed in Korea on May 24, 2011, which are hereby incorporated by reference for all purposes as if fully set forth herein.

### BACKGROUND OF THE INVENTION

1. Field of the Invention

The invention relates to a display device, and more particularly, to an image display device having an improved viewing angle and brightness.

2. Discussion of the Related Art

Human beings perceive a depth and a three-dimensional effect due to psychological and memorial factors in addition to a binocular disparity from a separation distance of eyes. From theses, three-dimensional image display devices are classified into a holographic type, a stereographic type, and a volumetric type depending on the extent of three-dimensional image information provided to the viewer.

The volumetric type, in which perspective along a depth direction is perceived due to psychological factors and inhalation effects, is used for three-dimensional computer graphics of calculating and displaying perspective, superposition, shade and shadow, light and darkness, motion, and so on, or I-MAX movies of causing an optical illusion in which the viewer is provided with a large screen having wide viewing angles and seems to be sucked into the space.

The holographic type, which is the most perfect three-dimensional image display technology, is used for a holographic image using a laser or a white ray.

The stereographic type uses a physiological factor of both eyes to perceive the three-dimensional effect. More particularly, the stereographic type uses stereography in which, when linked two-dimensional images including parallax information are provided to left- and right-eyes spaced apart from each other with a distance of about 65 mm, a brain produces space information about the front and the rear of the screen during merging them and thus perceives the three-dimensional effect.

The stereographic type may be referred to as a multi-view image display type. The stereographic type may be classified into a glasses type, where the user wears specific glasses, and a glasses-free type, in which a parallax barrier or a lens array such as lenticular or integral is used at a display side, depending a position in which a substantial three-dimensional effect is produced.

The glasses type has wider viewing angles and causes less dizziness than the glasses-free type. In addition, the glasses type can be manufactured with relatively low costs, and, specially, the glasses type can be manufactured with very low costs as compared with the hologram type. Moreover, in the glasses type, since the viewer wears the glasses to watch three-dimensional stereoscopic images and does not wear the glasses to watch two-dimensional images, there is an advantage that one display device can be used for displaying both two-dimensional images and three-dimensional stereoscopic images.

The glasses type may be classified into a shutter glasses type and a polarization glasses type. In the shutter glasses type, left- and right-eye images are alternately displayed in a screen, sequential opening and closing timing of a left shutter and a right-shutter of the shutter glasses is accorded with alternation time of the left- and right-eye images, and the respective images are separately perceived by the left eye and the right eye, thereby producing the three-dimensional effect.

In the polarization glasses type, pixels of a screen are divided into two by columns, rows or pixels, left- and right-eye images are displayed in different polarization directions, the left-glass and the right-glass of the polarization glasses have different polarization directions, and the respective images are separately perceived by the left eye and the right eye, thereby producing the three-dimensional effect.

The shutter glasses type needs to increase alternation numbers per unit time in order to reduce fatigue and improve the three-dimensional effect. By the way, when a liquid crystal display device is used for the shutter glasses type, liquid crystal has slow response time, and screen addressing timing of a scan type is not completely accorded with the alternation timing of the images. Thus, flicker may occur, and this may cause fatigue such as dizziness while watching the images.

On the other hand, the polarization glasses type does not have factors of causing flicker, and fatigue is less caused while watching the images. The polarization glasses type may cause a reduction by half in monocular resolution because the pixels of the screen are divided into two by columns, rows or pixels. However, since current display panels have high resolution and it is possible to further increase the resolution in the future, the reduction by half in monocular resolution of the polarization glasses type is not a problem.

In addition, the shutter glasses type should have hardware or circuits in the display device for alternation display and needs expensive shutter glasses. Costs are raised as viewers are increased. On the other hand, the polarization glasses type can use a polarization dividing optical member, which is patterned to divide polarized light, for example, a patterned retarder or a micro polarizer, on a front surface of a display panel, and at this time, the viewer can wear polarization glasses, which are very cheaper than the shutter glasses, to watch it. Accordingly, costs of the polarization glasses type are relatively low.

FIG. 1 is a perspective view of illustrating a polarized glasses-type three-dimensional image display device according to the related art.

In FIG. 1, the polarized glasses-type three-dimensional image display device 10 according to the related art includes a display panel 20 displaying an image, a polarizing film 50 over the display panel 20, and a patterned retarder 60 over the polarizing film 50.

The display panel 20 includes display areas DA substantially displaying the image and non-display areas NDA between adjacent display areas DA. The display areas DA include left-eye horizontal pixel lines Hl and right-eye horizontal pixel lines Hr.

The left-eye horizontal pixel lines Hl displaying a left-eye image and the right-eye horizontal pixel lines Hr displaying a right-eye image are alternately arranged along a vertical direction of the display panel 20 in the context of the figure. Red, green and blue sub-pixels R, G and B are sequentially arranged in each of the left-eye horizontal pixel lines Hl and the right-eye horizontal pixel lines Hr.

The polarizing film 50 changes the left-eye image and the right-eye image displayed by the display panel 20 into a linearly-polarized left-eye image and a linearly-polarized right-eye image, respectively, and transmits the linearly-polarized left-eye image and the linearly-polarized right-eye image to the patterned retarder 60.

The patterned retarder 60 includes left-eye retarders Rl and right-eye retarders Rr. The left-eye retarders Rl and the right-eye retarders Rr correspond to the left-eye horizontal pixel lines Hl and the right-eye horizontal pixel lines Hr, respectively, and are alternately arranged along the vertical direction of the display panel 20 in the context of the figure. The left-eye retarders Rl change linearly-polarized light into left-circularly polarized light, and the right-eye retarders Rr change linearly-polarized light into right-circularly polarized light.

Therefore, a left-eye image displayed by the left-eye horizontal pixel lines Hl of the display panel 20 is linearly polarized when passing through the polarizing film 50, is left-circularly polarized when passing through the left-eye retarders Rl of the patterned retarder 60, and is transmitted to the viewer. A right-eye image displayed by the right-eye horizontal pixel lines Hr of the display panel 20 is linearly polarized when passing through the polarizing film 50, is right-circularly polarized when passing through the right-eye retarders Rr of the patterned retarder 60, and is transmitted to the viewer.

Polarized glasses 80 which the viewer wears include a left-eye lens 82 and a right-eye lens 84. The left-eye lens 82 transmits only left-circularly polarized light, and the right-eye lens 84 transmits only right-circularly polarized light.

Accordingly, among the images transmitted to the viewer, the left-circularly polarized left-eye image is transmitted to the left-eye of the viewer through the left-eye lens 82, and the right-circularly polarized right-eye image is transmitted to the right-eye of the viewer through the right-eye lens 84. The viewer combines the left-eye image and the right-eye image respectively transmitted to the left-eye and the right-eye and realizes a three-dimensional stereoscopic image.

FIG. 2 is a cross-sectional view of a polarized glasses-type three-dimensional image display device according to the related art, which includes a liquid crystal display panel as a display panel.

In FIG. 2, a display panel 20 includes first and second substrates 22 and 40 facing and spaced apart from each other and a liquid crystal layer 48 interposed between the first and second substrates 22 and 40.

A gate line (not shown) and a gate electrode 24 connected to the gate line are formed on an inner surface of the first substrate 22. A gate insulating layer 26 is formed on the gate line and the gate electrode 24.

A semiconductor layer 28 is formed on the gate insulating layer 26 corresponding to the gate electrode 24. Source and drain electrodes 32 and 34 spaced apart from each other and a data line (not shown) connected to the source electrode 32 are formed on the semiconductor layer 28. The data line crosses the gate line to define a pixel region.

Here, the gate electrode 24, the semiconductor layer 28, the source electrode 32 and the drain electrode 34 form a thin film transistor T.

A passivation layer 36 is formed on the source electrode 32, the drain electrode 34 and the data line, and the passivation layer 36 has a drain contact hole 36a exposing the drain electrode 34.

A pixel electrode 38 is formed on the passivation layer 36 in the pixel region and is connected to the drain electrode 34 through the drain contact hole 36a.

A black matrix 42 is formed on an inner surface of the second substrate 40. The black matrix 42 has an opening corresponding to the pixel region and corresponds to the gate line, the data line and the thin film transistor T. A color filter layer 44 is formed on the black matrix 42 and on the inner surface of the second substrate 40 exposed through the opening of the black matrix 42. Although not shown in the figure, the color filter layer 44 includes red, green and blue color filters, each of which corresponds to one pixel region.

A transparent common electrode 46 is formed on the color filter layer 44.

The liquid crystal layer 48 is disposed between the pixel electrode 38 of the first substrate 22 and the common electrode 46 of the second substrate 40. Although not shown in the figure, alignment layers, which determine initial arrangements of liquid crystal molecules, are formed between the liquid crystal layer 48 and the pixel electrode 38 and between the liquid crystal layer 48 and the common electrode 46, respectively.

Meanwhile, a first polarizer 52 is disposed on an outer surface of the first substrate 22, and a second polarizer 50 is disposed on an outer surface of the second substrate 40. The second substrate 50 corresponds to the polarizing film of FIG. 1. The first and second polarizers 52 and 50 transmit linearly polarized light, which is parallel to their transmission axes. The transmission axis of the first polarizer 52 is perpendicular to the transmission axis of the second polarizer 50.

A patterned retarder 60 is attached on the second polarizer 50. The patterned retarder 60 includes a base film 62, a retarder layer 64, a black stripe 66 and an adhesive layer 68.

The retarder layer 64 includes left-eye retarders Rl and right-eye retarders Rr, which are alternately arranged along a vertical direction of the device. The black stripe 66 corresponds to borders between the left-eye retarders Rl and the right-eye retarders Rr.

The left-eye retarders Rl and the right-eye retarders Rr have a retardation value of λ/4, and their optical axes make angles of +45 degrees and −45 degrees with respect to a polarized direction of the linearly polarized light transmitted from display panel 20 and the second polarizer 50.

The black stripe 66 prevents three dimensional (3D) crosstalk where the left-eye and right-eye images are simultaneously transmitted to the left-eye or the right-eye of the viewer, thereby improving 3D viewing angles along the up and down direction of the device.

Alternatively, to prevent the 3D crosstalk, the black matrix 42 in the display device may have a widened width instead of forming the black stripe 66.

An improvement in the 3D crosstalk and the 3D viewing angles using the black stripe or black matrix will be explained with reference to accompanying drawings.

FIGS. 3A to 3C are schematic cross-sectional views of showing 3D crosstalk in the related art polarized glasses-type three-dimensional image display device. FIG. 3A shows the device without the black stripe, FIG. 3B shows the device with the black stripe, and FIG. 3C the device with the black matrix having the widened width instead of the black stripe.

Although not shown in the figures, at the front viewing angle and the left and right viewing angles of the polarized glasses-type three-dimensional image display device 10, the left-eye image Il displayed by the left-eye horizontal pixel lines Hl of the display panel 20 is left-circularly polarized when passing through the left-eye retarders Rl of the patterned retarder 60 and is transmitted the viewer, and the right-eye image Ir displayed by the right-eye horizontal pixel lines Hr of the display panel 20 is right-circularly polarized when passing through the right-eye retarders Rr of the patterned retarder 60 and is transmitted to the viewer. Thus, there is no 3D crosstalk due to mixing of the left-eye image Il and the right-eye image Ir.

However, as shown in FIG. 3A, at the up and down viewing angles of the polarized glasses-type three-dimensional image display device 10, some of the left-eye image Il displayed by the left-eye horizontal pixel lines Hl of the display panel 20 passes through the right-eye retarder Rr of the patterned retarder 60 and is right-circularly polarized.

Namely, the right-eye image Ir and some of the left-eye image Il are right-circularly polarized and are transmitted to the right-eye of the viewer through the right-eye lens 84 of the polarized glasses 80. Therefore, the right-eye image Ir and some of the left-eye image Il interfere with each other, and 3D crosstalk occurs. The 3D viewing angle properties along the up and down direction are lowered.

The interference in the left-eye image Il and the right-eye image Ir may be decreased due to the non-display areas NDA between the display areas DA having a first height h1 of the display panel 20. Since the display panel 20 is rather far from the patterned retarder 60, the effect for preventing the 3D crosstalk is insignificant.

To improve this, as shown in FIG. 3B, the black stripe 66 may be formed between the left-eye retarder Rl and the right-eye retarder Rr of the patterned retarder 60, or as shown in FIG. 3C, the black matrix 43 in the display panel 20 may have the widened width without the black stripe.

Here, some of the left-eye image Il, which is displayed by the left-eye horizontal pixel lines Hl of the display panel 20 and proceeds to the right-eye retarder Rr of the patterned retarder 60, is blocked by the black stripe 66 or the black matrix 43. Thus, some of the left-eye image Il is not right-circularly polarized and is not outputted.

That is to say, only the right-eye image Ir is right-circularly polarized and is transmitted to the right-eye of the viewer through the right-eye lens 84 of the polarized glasses 80. The 3D crosstalk due to the interference of the right-eye image Ir and some of the left-eye image Il is prevented, and the 3D viewing angle properties along the up and down direction are improved.

However, the display panel 20 includes a black stripe area BS, which is larger than the non-display area NDA, due to the black stripe 66, and the display area DA is substantially decreased to have a second height h2 smaller than the first height h1. Or, the non-display area NDA is increased due to the black matrix 43, and the display area DA is decreased to have a third height h3 smaller than the first height h1. Accordingly, the aperture ratio and the brightness are decreased.

### SUMMARY OF THE INVENTION

Accordingly, the present invention is directed to a three-dimensional image display device that substantially obviates one or more of the problems due to limitations and disadvantages of the related art.

An object of the present invention is to provide to a three-dimensional image display device that improves 3D viewing angle properties and increases the aperture ratio and the brightness by preventing the 3D crosstalk.

Another object of the present invention is to provide a two-dimensional image display device having the improved brightness.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of embodiments of the invention, as embodied and broadly described, a image display device includes a display panel including a display area and a non-display area, wherein the display area includes left-eye horizontal pixel lines displaying a left-eye image and right-eye horizontal pixel lines displaying a right-eye image; a polarizing film disposed over the display panel, wherein the polarizing film linearly polarizes the left-eye image and the right-eye image; a patterned retarder disposed over the polarizing film and including left-eye retarders and right-eye retarders, wherein the left-eye retarders correspond to the left-eye horizontal pixel lines and change the linearly polarized left-eye image into left-circularly polarized image, and the right-eye retarders correspond to the right-eye horizontal pixel lines and change the linearly polarized image into right-circularly polarized image; and a lenticular lens film disposed over the polarizing film and including lenticular lenses, wherein the lenticular lenses correspond to the left-eye retarders and the right-eye retarders, respectively.

In another aspect, an image display device includes a display panel including horizontal pixel lines, each of which comprises a plurality of pixels, a linear polarizing film disposed over the display panel, and a lenticular lens film disposed over the linear polarizing film and including lenticular lenses, wherein the lenticular lenses correspond to the horizontal pixel lines.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view of illustrating a polarized glasses-type three-dimensional image display device according to the related art;

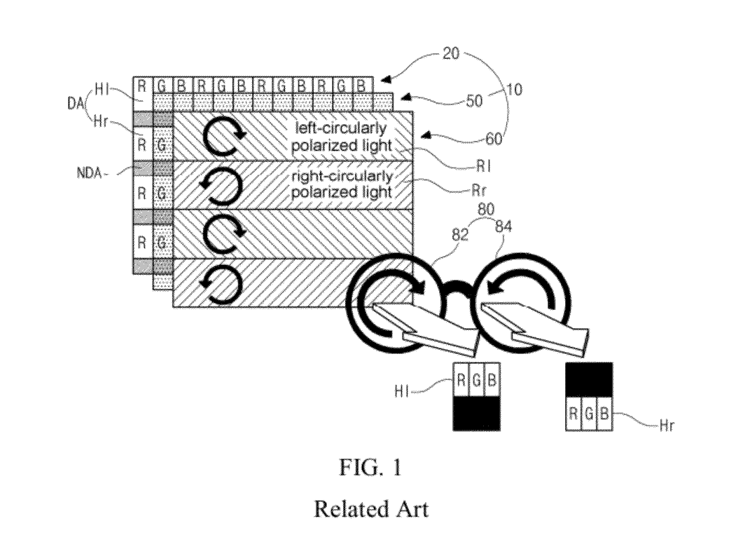

FIG. 2 is a cross-sectional view of a polarized glasses-type three-dimensional image display device according to the related art, which includes a liquid crystal display panel as a display panel;

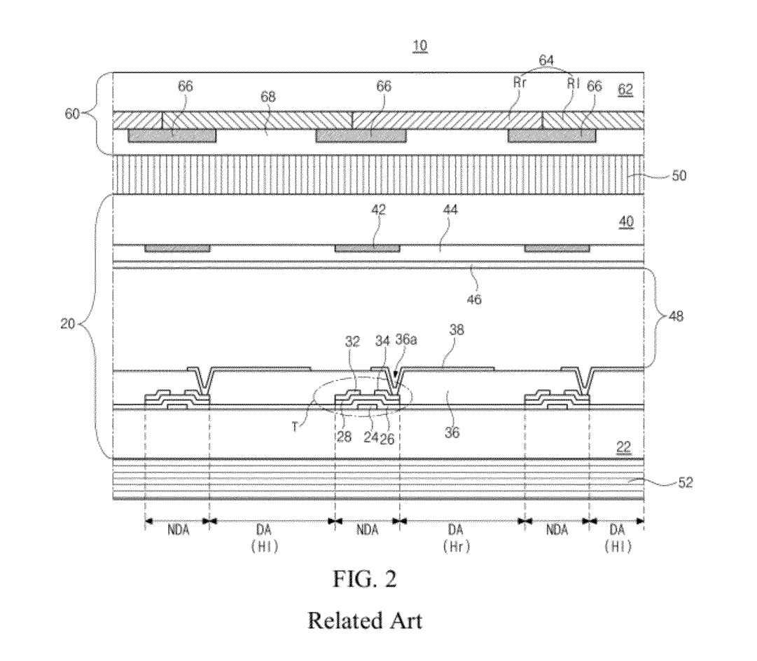

FIGS. 3A to 3C are schematic cross-sectional views of showing 3D crosstalk in the related art polarized glasses-type three-dimensional image display device;

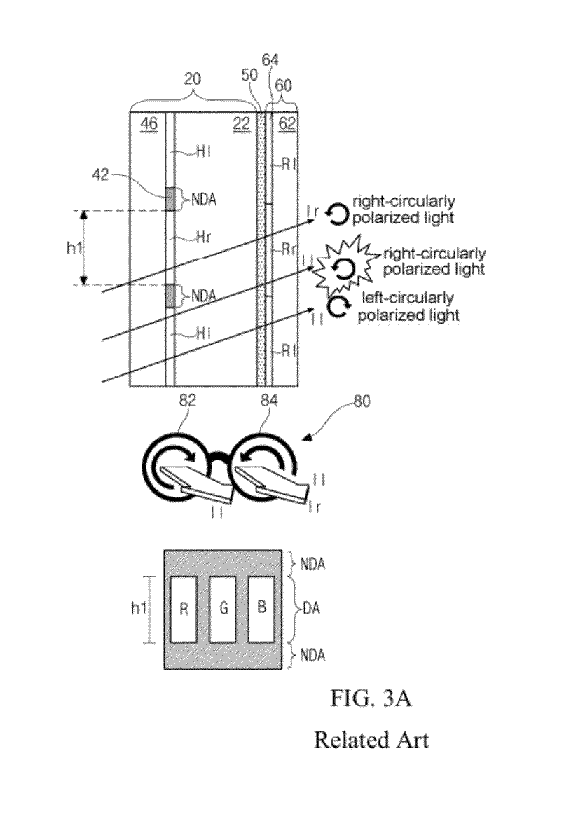

FIG. 4 is a perspective view of illustrating a polarized glasses-type three-dimensional image display device according to an exemplary embodiment of the present invention;

FIG. 5 is a cross-sectional view of a polarized glasses-type three-dimensional image display device according to an exemplary embodiment of the present invention;

FIG. 6 is a schematic view for calculating a 3D crosstalk in a three-dimensional image display device according to an exemplary embodiment of the present invention;

FIG. 7 is a graph of showing simulation results of 3D crosstalk versus refractive angles in three-dimensional image display devices having different conditions according to the present invention; and

FIG. 8 is a graph of showing brightness versus refractive angles in three-dimensional image display devices having different focal lengths according to the present invention.

FIG. 9 is a cross-sectional view of a two-dimensional image display device including a lenticular lens film according to an exemplary embodiment of the present invention.

FIG. 10A and FIG. 10B are views of illustrating paths of light in a two-dimensional image display device before and after attaching lenticular lenses, respectively.

FIG. 11A and FIG. 11B are pictures of a two-dimensional image display device before and after attaching lenticular lenses, respectively.

FIG. 12A is a schematic view of illustrating an image display device for measuring the brightness depending on the presence of lenticular lenses.

FIG. 12B is a graph of showing the brightness at each point of FIG. 12A.

### DETAILED DESCRIPTION OF EXEMPLARY EMBODIMENTS

Reference will now be made in detail to exemplary embodiments of the invention, which are illustrated in the accompanying drawings.

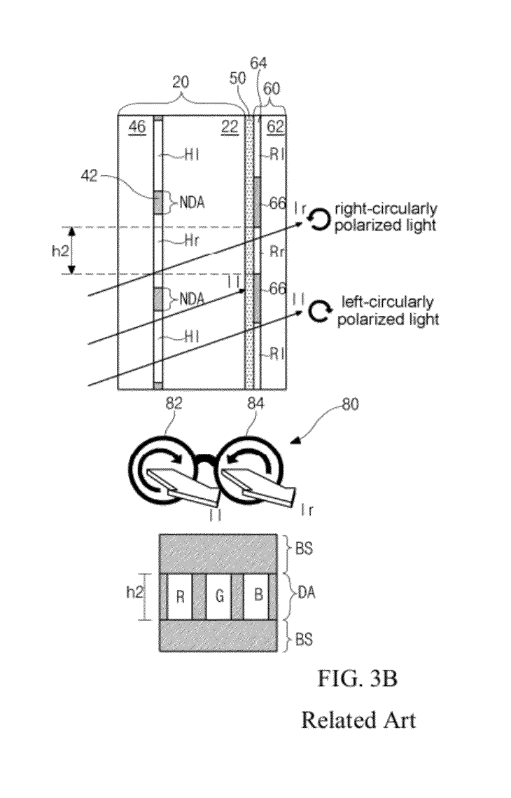

FIG. 4 is a perspective view of illustrating a polarized glasses-type three-dimensional image display device according to an exemplary embodiment of the present invention.

In FIG. 4, the polarized glasses-type three-dimensional image display device 110 of the present invention includes a display panel 120 displaying an image, a polarizing film 150 over the display panel 120, a patterned retarder 160 over the polarizing film 150, and a lenticular lens film 170 over the patterned retarder 160. Here, the lenticular lens film 170 may be a sheet shape.

The display panel 120 includes display areas DA substantially displaying the image and non-display areas NDA between adjacent display areas DA. The display areas DA include left-eye horizontal pixel lines Hl and right-eye horizontal pixel lines Hr.

The left-eye horizontal pixel lines Hl displaying a left-eye image and the right-eye horizontal pixel lines Hr displaying a right-eye image are alternately arranged along a vertical direction of the display panel 120 in the context of the figure. Red, green and blue sub-pixels R, G and B are sequentially arranged in each of the left-eye horizontal pixel lines Hl and the right-eye horizontal pixel lines Hr.

The polarizing film 150 changes the left-eye image and the right-eye image displayed by the display panel 120 into a linearly-polarized left-eye image and a linearly-polarized right-eye image, respectively, and transmits the linearly-polarized left-eye image and the linearly-polarized right-eye image to the patterned retarder 160.

The patterned retarder 160 includes left-eye retarders Rl and right-eye retarders Rr. The left-eye retarders Rl and the right-eye retarders Rr correspond to the left-eye horizontal pixel lines Hl and the right-eye horizontal pixel lines Hr, respectively, and are alternately arranged along the vertical direction of the display panel 120 in the context of the figure. The left-eye retarders Rl change linearly-polarized light into left-circularly polarized light, and the right-eye retarders Rr change linearly-polarized light into right-circularly polarized light.

The lenticular lens film 170 concentrates the left-circularly polarized light or the right-circularly polarized light from the patterned retarder 160 upon a predetermined direction and improves the viewing angles along the up and down direction of the device in the context of the figure. The lenticular lens film 170 includes a plurality of lenticular lenses 174 arranged along the vertical direction of the display panel 120 in the context of the figure. Each lenticular lens 174 corresponds to one of the left-eye retarders Rl or one of the right-eye retarders Rr.

Here, a lens pitch P_{L} of the lenticular lens film 170, which is defined as a width of each lenticular lens 174 or a distance between peaks of adjacent lenticular lenses 174, has a difference of about ±5 μm from a pixel pitch P_{P} of the display panel 120, which is defined as a distance from an upper end of a pixel to an upper end of a next pixel along the vertical direction of the display panel in the context of the figure. Beneficially, the lens pitch P_{L} is smaller than or equal to the pixel pitch P_{P}.

At this time, the lens pitch and the pixel pitch may correspond to each other such that a central portion of the lenticular lens film 170 is aligned with a central portion of the display panel 120.

Therefore, a left-eye image displayed by the left-eye horizontal pixel lines Hl of the display panel 120 is linearly polarized when passing through the polarizing film 150, is left-circularly polarized when passing through the left-eye retarders Rl of the patterned retarder 160, and is put toward a first direction when passing through the lenticular lens film 170. A right-eye image displayed by the right-eye horizontal pixel lines Hr of the display panel 120 is linearly polarized when passing through the polarizing film 150, is right-circularly polarized when passing through the right-eye retarders Rr of the patterned retarder 160, and is put toward the first direction when passing through the lenticular lens film 170. Accordingly, the left-eye image and the right-eye image put toward the first direction are transmitted to the viewer.

Polarized glasses 180 which the viewer wears include a left-eye lens 182 and a right-eye lens 184. The left-eye lens 182 transmits only left-circularly polarized light, and the right-eye lens 184 transmits only right-circularly polarized light.

Accordingly, among the images transmitted to the viewer, the left-circularly polarized left-eye image is transmitted to the left-eye of the viewer through the left-eye lens 182, and the right-circularly polarized right-eye image is transmitted to the right-eye of the viewer through the right-eye lens 184. The viewer combines the left-eye image and the right-eye image respectively transmitted to the left-eye and the right-eye and realizes a three-dimensional stereoscopic image.

At this time, some of the left-eye image may be right-circularly polarized by passing through the right-eye retarders Rr of the patterned retarder 160, or some of the right-eye image may be left-circularly polarized by passing through the left-eye retarders Rl of the patterned retarder 160. However, the right-circularly polarized left-eye image or the left-circularly polarized right-eye image may be put toward a second direction different from the first direction when passing through the lenticular lens film 170. Therefore, the 3D crosstalk due to interference of the left-eye image and the right-eye image can be prevented, and the viewing angle properties can be improved.

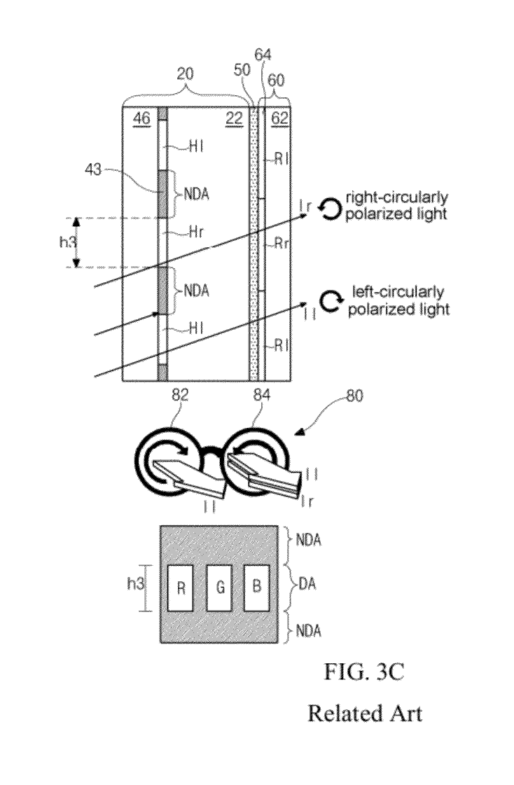

FIG. 5 is a cross-sectional view of a polarized glasses-type three-dimensional image display device according to an exemplary embodiment of the present invention.

In FIG. 5, a display panel 120 includes first and second substrates 122 and 140 facing and spaced apart from each other and a liquid crystal layer 148 interposed between the first and second substrates 122 and 140.

A gate line (not shown) and a gate electrode 124 connected to the gate line are formed on an inner surface of the first substrate 122. A gate insulating layer 126 is formed on the gate line and the gate electrode 124.

A semiconductor layer 128 is formed on the gate insulating layer 126 corresponding to the gate electrode 124. Source and drain electrodes 132 and 134 spaced apart from each other and a data line (not shown) connected to the source electrode 132 are formed on the semiconductor layer 128. The data line crosses the gate line to define a pixel region. Although not shown in the figure, the semiconductor layer 128 includes an active layer of intrinsic amorphous silicon and ohmic contact layers of impurity-doped amorphous silicon. The ohmic contact layers may have the same shape as the source and drain electrodes 132 and 134.

Here, the gate electrode 124, the semiconductor layer 128, the source electrode 132 and the drain electrode 134 form a thin film transistor T.

A passivation layer 136 is formed on the source electrode 132, the drain electrode 134 and the data line, and the passivation layer 136 has a drain contact hole 136a exposing the drain electrode 134.

A pixel electrode 138 is formed on the passivation layer 136 in the pixel region and is connected to the drain electrode 134 through the drain contact hole 136a.

A black matrix 142 is formed on an inner surface of the second substrate 140. The black matrix 142 has an opening corresponding to the pixel region and corresponds to the gate line, the data line and the thin film transistor T. Here, the opening corresponds to the display area DA, and the black matrix 142 corresponds to the non-display area NDA. A color filter layer 144 is formed on the black matrix 142 and on the inner surface of the second substrate 140 exposed through the opening of the black matrix 142. Although not shown in the figure, the color filter layer 144 includes red, green and blue color filters, each of which corresponds to one pixel region. The red, green and blue color filters are sequentially and repeatedly disposed along a horizontal direction of the display panel 120 as shown in FIG. 4. The same color filters are disposed along the vertical direction of the display panel 120 in the context of the figure. A transparent common electrode 146 is formed on the color filter layer 144.

Meanwhile, although not shown in the figure, an overcoat layer may be formed between the color filter layer 144 and the common electrode 146 to protect the color filter layer 144 and to flatten a surface of the second substrate 140 including the color filter layer 144.

The liquid crystal layer 148 is disposed between the pixel electrode 138 of the first substrate 122 and the common electrode 146 of the second substrate 140. Although not shown in the figure, alignment layers, which determine initial arrangements of liquid crystal molecules, are formed between the liquid crystal layer 148 and the pixel electrode 138 and between the liquid crystal layer 148 and the common electrode 146, respectively.

Even though, in this embodiment, the pixel electrode 138 and the common electrode 146 are formed on the first and second substrates 122 and 140, respectively, both the pixel electrode 138 and the common electrode 146 may be formed on the first substrate 122.

In the meantime, a first polarizer 152 is disposed on an outer surface of the first substrate 122, and a second polarizer 150 is disposed on an outer surface of the second substrate 140. The first and second polarizers 152 and 150 transmit linearly polarized light, which is parallel to their transmission axes. The transmission axis of the first polarizer 152 is perpendicular to the transmission axis of the second polarizer 150. Adhesive layers may be disposed between the first substrate 122 and the first polarizer 152 and between the second substrate 140 and the second polarizer 150.

Although not shown in the figure, a backlight unit is disposed under the first polarizer 152 to provide light to the display panel 120.

Here, a liquid crystal panel is used as the display panel 120. Alternatively, an organic electroluminescent display panel may be used as the display panel 120. In this case, the first polarizer 152 may be omitted, and a λ/4 plate (quarter wave plate: QWP) and a linear polarizer may be used in place of the second polarizer 150.

A patterned retarder 160 is attached on the second polarizer 150. The patterned retarder 160 includes a first base film 162, a retarder layer 164 and an adhesive layer 168. The retarder layer 164 includes left-eye retarders Rl and right-eye retarders Rr, which are alternately arranged along a vertical direction of the device. The adhesive layer 168 contacts the second polarizer 150, and the retarder layer 164 is disposed between the first base film 162 and the second polarizer 150. Here, the positions of the retarder layer 164 and the first base film 162 may be changed. That is, the adhesive layer 168, which contacts the second polarizer 150, is formed on a first surface of the first base film 162, and the retarder layer 164 is formed on a second surface of the first base film 162.

The first base film 162 may be formed of tri-acetyl cellulose (TAC) or cyclo olefin polymer (COP).

The left-eye retarders Rl and the right-eye retarders Rr have a retardation value of λ/4, and their optical axes make angles of +45 degrees and −45 degrees with respect to a polarized direction of the linearly polarized light transmitted through the second polarizer 150 from the display panel 120.

A lenticular lens film 170 is disposed on the patterned retarder 160. The lenticular lens film 170 includes a second base film 172 and lenticular lenses 174. Although not shown in the figure, the base film 172 may be attached to the patterned retarder 160 with an adhesive layer.

The second base film 172 may be formed of polyethylene terephthalate (PET). However, since PET is cheap and has retardation values due to birefringence, PET may cause a change in polarization. For example, PET has the in-plane retardation value Rin of 130 nm and the thickness retardation value Rth of −4300 nm. It is not easy to control light. Thus, it is desirable to use a material having zero birefringence or relatively low birefringence as the second base film 172. Beneficially, the second base film 172 may have the in-plane retardation value Rin within a range of −10 nm to +10 nm, more beneficially, of 0 nm, and the thickness retardation value Rth within a range of −50 nm to +50 nm. The second base film 172 may include tri-acetyl cellulose (TAC), cyclo-olefin polymer (COP) or an acrylic material having zero retardation. For instance, TAC may have the in-plane retardation value Rin of 0 nm and the thickness retardation value Rth of −50 nm. The acrylic material having zero retardation may have the in-plane retardation value Rin of 0 nm and the retardation value Rth of 0 nm. The second base film 172 has a thickness of about 60 μm to about 80 μm.

The first base film 162 of the patterned retarder 160 may be omitted. In this case, the retarder layer 164 may be formed on an upper surface of the second polarizer 150 or may be formed on a lower surface of the second base film 172.

A lens pitch P_{L} of the lenticular lens film 170, which is defined as a width of each lenticular lens 174 or a distance between peaks of adjacent lenticular lenses 174, has a difference of about ±5 μm from a pixel pitch P_{P} of the display panel 120, which is defined as a distance from an upper end of a pixel to an upper end of a next pixel along the vertical direction of the display panel 120 in FIG. 4 and corresponds to a width of each left-eye retarder Rl or each right-eye retarder Rr of the patterned retarder 160. Beneficially, the lens pitch P_{L} is smaller than or equal to the pixel pitch P_{P}.

In the meantime, a thickness d of the lenticular lens 174 varies depending on a focal length due to a radius of curvature, and also, the maximum viewing angle changes depending on the focal length of the lenticular lens 174. A 3D crosstalk value can be predicted from an angle of light coming through the lenticular lens 174, and thus the maximum viewing angle can be determined.

For instance, in a 47 inch three-dimensional image display device, when the pixel pitch P_{P} is 541.5 μm, the lens pitch P_{L} may be within a range of 536.5 μm to 546.5 μm, and beneficially, may be less than 541.5 μm. In addition, the thickness d of the lenticular lens 174 may be within a range of about 20 μm to about 200 μm.

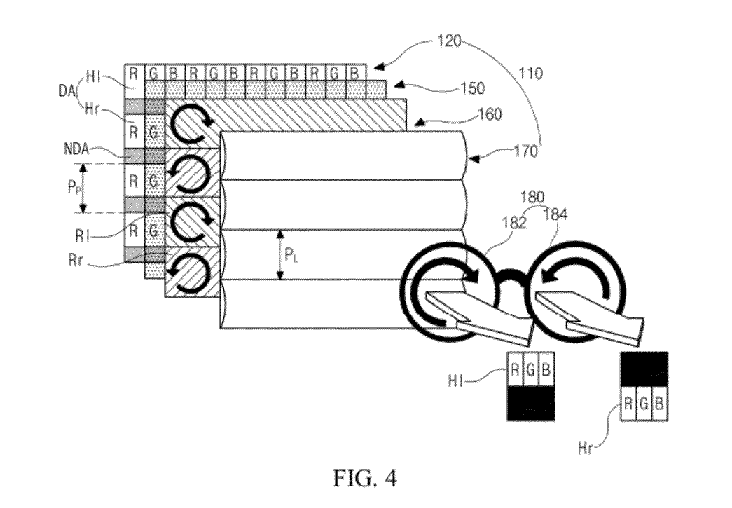

FIG. 6 is a schematic view for calculating a 3D crosstalk in a three-dimensional image display device according to an exemplary embodiment of the present invention.

In FIG. 6, an incident angle φ of light having a refractive angle θ can be expressed by equation (1) from Snell's Law.

φ=sin⁻¹(sin θ/n) equation (1)

Here, n is a refractive index of the lenticular lens 174 and is about 1.5, for example.

Meanwhile, the focal length of the lenticular lens 174 can be expressed by equation (2).

f=P²/(8·Δn·d) equation (2)

Here, P is the width of the lenticular lens 174, i.e., the lens pitch P_{L}, and Δn is a difference between a refractive index of the air and the refractive index of the lenticular lens 174, and d is the thickness of the lenticular lens 174.

Additionally, an angle ψ of light, which is incident on both ends of the lenticular lens 174 from one point, that is, the backlight unit (not shown), can be expressed by equation (3).

ψ=sin⁻¹{(4·Δn·d)/(P·cos²φ)} equation (3)

From equation (1) to equation (3), areas Ri and Li of the right-eye horizontal pixel line Hr and the left-eye horizontal pixel line Hl, which the light incident on both ends of the lenticular lens 174 from one point pass through, can be expressed by equation (4) and equation (5).

Ri=L·tan(φ−ψ)−(B/2) equation (4)

Li=P_{P}−(B/2)−L·tan(φ+ψ) equation (5)

Here, L is a distance from the display area DA of the display panel 120 to the lenticular lens 174, B is a width of the black matrix, that is, a width of the non-display area NDA, and PP is the pixel pitch, which is a sum of the widths of the display area DA and the non-display area NDA and corresponds to the width of the left-eye retarder or the right-eye retarder of the patterned retarder 160.

Therefore, the 3D crosstalk CT, which is Ri/Li, can be obtained from equation (4) and equation (5). When the 3D crosstalk CT is 7%, the device is determined to have the maximum viewing angle.

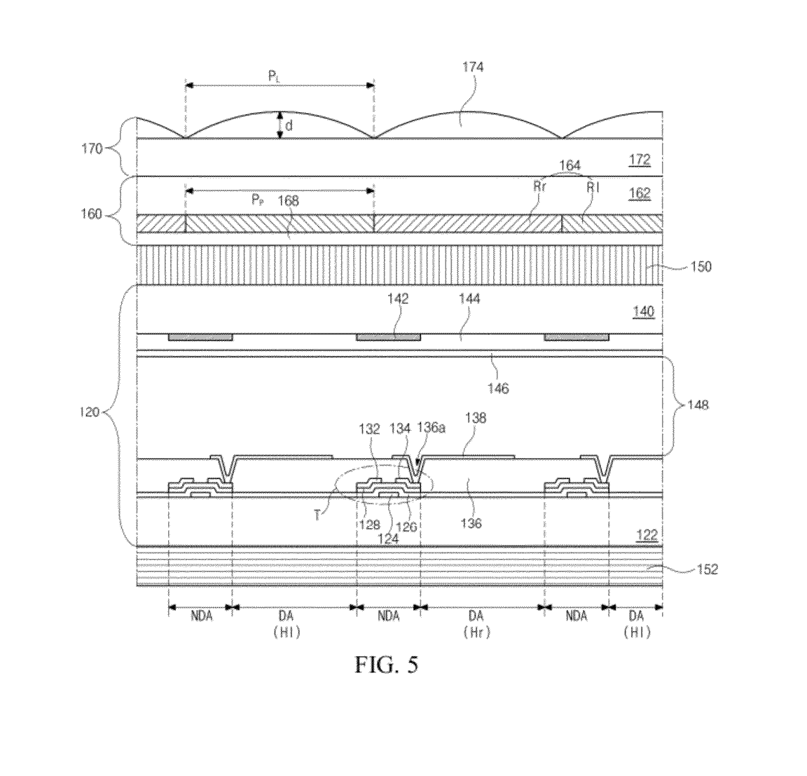

FIG. 7 is a graph of showing simulation results of 3D crosstalk versus refractive angles in three-dimensional image display devices having different conditions such as focal lengths or widths of the black matrix according to the present invention. Table 1 shows the maximum viewing angles obtained from the graph of FIG. 7. Here, a 47 inch display panel is applied to each of experimental examples and comparative examples.

TABLE 1

| | | | | viewing angle |
|---|---|---|---|---|
| | f(μm) | NDA(μm) | L(μm) | (degrees) |
| comparative | None | 70 | 900 | 11.0 |
| example 1 | | | | |
| comparative | None | 240 | 900 | 25.6 |
| example 2 | | | | |
| experimental | 2050 | 70 | 900 | 32.4 |
| example 1 | | | | |
| experimental | 2050 | 240 | 900 | 48.3 |
| example 2 | | | | |
| experimental | 1450 | 70 | 900 | 42.6 |
| example 3 | | | | |
| experimental | 1450 | 70 | 700 | 46.3 |
| example 4 | | | | |

In experimental example 1, the focal length f of the lenticular lens 174 of FIG. 6 is 2050 μm, the width of the black matrix, i.e., the width of the non-display area NDA of FIG. 6 is 70 μm, and the distance L from the display area DA of FIG. 6 of the display panel 120 of FIG. 6 to the lenticular lens 174 of FIG. 6 is 900 μm.

In experimental example 2, the focal length f of the lenticular lens 174 of FIG. 6 is 2050 μm, the width of the black matrix, i.e., the width of the non-display area NDA of FIG. 6 is 240 μm, and the distance L from the display area DA of FIG. 6 of the display panel 120 of FIG. 6 to the lenticular lens 174 of FIG. 6 is 900 μm.

In experimental example 3, the focal length f of the lenticular lens 174 of FIG. 6 is 1450 μm, the width of the black matrix, i.e., the width of the non-display area NDA of FIG. 6 is 70 μm, and the distance L from the display area DA of FIG. 6 of the display panel 120 of FIG. 6 to the lenticular lens 174 of FIG. 6 is 900 μm.

In experimental example 4, the focal length f of the lenticular lens 174 of FIG. 6 is 1450 μm, the width of the black matrix, i.e., the width of the non-display area NDA of FIG. 6 is 70 μm, and the distance L from the display area DA of FIG. 6 of the display panel 120 of FIG. 6 to the lenticular lens 174 of FIG. 6 is 700 μm.

Meanwhile, the 3D crosstalk and the viewing angle are evaluated as comparative examples in which the lenticular lens is not used. In comparative example 1, the width of the black matrix or the black stripe is 70 μm, and the distance L from the display area DA of FIG. 6 of the display panel 120 of FIG. 6 including the patterned retarder 160 of FIG. 6 is 900 μm.

In comparative example 2, the width of the black matrix or the black stripe is 240 μm, and the distance L from the display area DA of FIG. 6 of the display panel 120 of FIG. 6 including the patterned retarder 160 of FIG. 6 is 900 μm.

From FIG. 7 and Table 1, it is noted that the maximum viewing angle increases as the width of the black matrix or the black stripe, that is, the width of the non-display area NDA increases. However, the aperture ratio decreases, and the brightness is lowered due to the increase in the width of the non-display area NDA. The brightness of comparative example 2 is lowered by 65% of the brightness of the comparative example 1.

In addition, from FIG. 7 and Table 1, it is noted that the maximum viewing angle increases as the focal length of the lenticular lens is shortened. The viewing angle of experimental example 1 or experimental example 3, in which the lenticular lens is used and the width of the non-display area NDA is minimized, is larger than comparative example 2.

Accordingly, the viewing angle along the up and down direction of the device can be improved by using the lenticular lens, and the width of the non-display area NDA, that is, the width of the black matrix can be minimized.

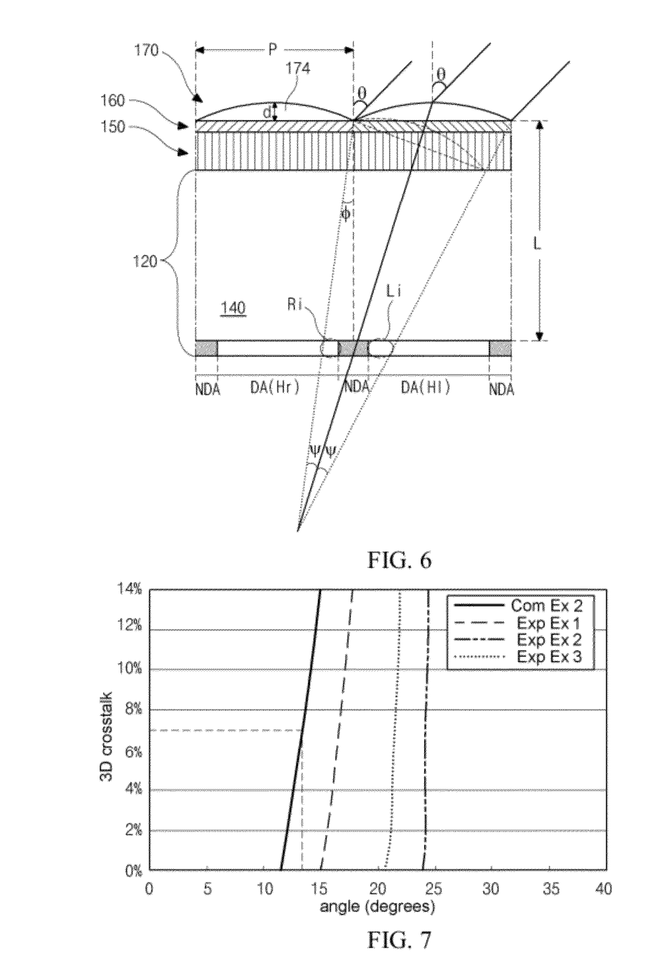

FIG. 8 is a graph of showing brightness versus refractive angles in three-dimensional image display devices having different focal lengths according to the present invention. Table 2 shows the maximum viewing angles depending on the focal lengths of FIG. 8. Here, a 47 inch display panel is applied to each of experimental examples and comparative examples.

TABLE 2

| | | viewing angle |
|---|---|---|
| | f(μm) | (degrees) |
| comparative example 3 | None | 12.6 |
| experimental example 5 | 6000 | 18.1 |
| experimental example 6 | 3000 | 25.1 |
| experimental example 7 | 1500 | 40.2 |

In experimental example 5, the focal length f of the lenticular lens 174 of FIG. 6 is 6000 μm. In experimental example 6, the focal length f of the lenticular lens 174 of FIG. 6 is 3000 μm. In experimental example 7, the focal length f of the lenticular lens 174 of FIG. 6 is 1500 μm.

In comparative example 3, the lenticular lens is not used.

From FIG. 8 and Table 2, it is noted that the maximum viewing angle increases as the focal length f of the lenticular lens 174 of FIG. 6 is shortened and the picket fence effect, in which the brightness is lowered, occurs at certain viewing angles.

Here, in experimental example 6 where the focal length f of the lenticular lens 174 of FIG. 6 is 3000 μm, the maximum viewing angle is 26.1 degrees, which is similar to 25.6 degrees of the maximum viewing angle of comparative example 2 having the width of non-display area NDA of 240 μm as shown in Table 1, and the brightness over the viewing angles is about 80%.

Therefore, when the focal length f of the lenticular lens 174 of FIG. 6 is within a range of about 2000 μm to about 3000 μm, excellent viewing angle properties can be achieved without lowering the brightness.

Furthermore, when the brightness of the backlight unit is raised, a wider viewing angle can be obtained with a shorter focal length f, and the picket fence effect at certain viewing angles can be prevented. Accordingly, the viewing angle properties can be further improved.

In the above-mentioned embodiment, the patterned retarder 160 of FIG. 4 is disposed on the polarizing film 150 of FIG. 4, and the lenticular lens film 170 of FIG. 4 is disposed on the patterned retarder 160 of FIG. 4. The positions of the patterned retarder 160 of FIG. 4 and the lenticular lens film 170 of FIG. 4 may be changed. Namely, the lenticular lens film may be disposed on the polarizing film 150 of FIG. 4, and the patterned retarder may be disposed on the lenticular lens film.

Alternatively, the patterned retarder 160 of FIG. 4 may be omitted, and the lenticular lens film 170 of FIG. 4 may function as the patterned retarder. At this time, each lenticular lens of the lenticular lens film 170 of FIG. 4 may have a retardation value of λ/4, and its optical axes make angles of +45 degrees and −45 degrees with respect to a polarized direction of the linearly polarized light transmitted through the polarizing film 150 of FIG. 4 from the display panel 120 of FIG. 4.

In the above-mentioned embodiment, the lenticular lens film 170 of FIG. 4 is applied to a three-dimensional image display device, and the lenticular lens film may be applied to a two-dimensional image display device.

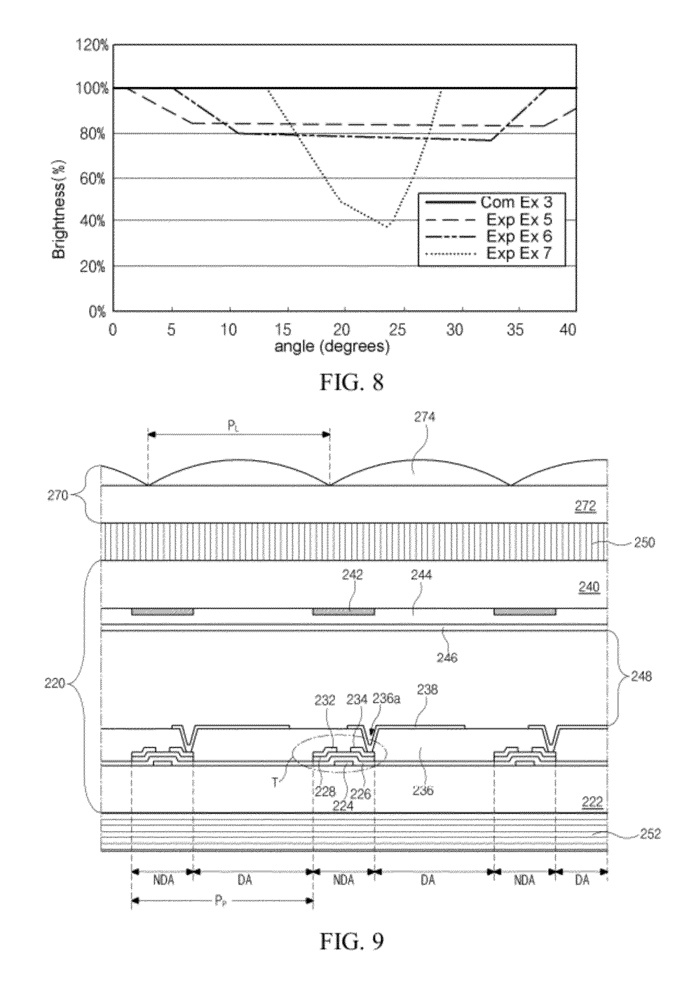

FIG. 9 is a cross-sectional view of a two-dimensional image display device including a lenticular lens film according to an exemplary embodiment of the present invention.

In FIG. 9, a display panel 220 includes first and second substrates 222 and 240 facing and spaced apart from each other and a liquid crystal layer 248 interposed between the first and second substrates 222 and 240.

A gate line (not shown) and a gate electrode 224 connected to the gate line are formed on an inner surface of the first substrate 222. A gate insulating layer 226 is formed on the gate line and the gate electrode 224.

A semiconductor layer 228 is formed on the gate insulating layer 226 corresponding to the gate electrode 224. Source and drain electrodes 232 and 234 spaced apart from each other and a data line (not shown) connected to the source electrode 232 are formed on the semiconductor layer 228. The data line crosses the gate line to define a pixel region. Although not shown in the figure, the semiconductor layer 228 includes an active layer of intrinsic amorphous silicon and ohmic contact layers of impurity-doped amorphous silicon. The ohmic contact layers may have the same shape as the source and drain electrodes 232 and 234.

Here, the gate electrode 224, the semiconductor layer 228, the source electrode 232 and the drain electrode 234 form a thin film transistor T.

A passivation layer 236 is formed on the source electrode 232, the drain electrode 234 and the data line, and the passivation layer 236 has a drain contact hole 236a exposing the drain electrode 234.

A pixel electrode 238 is formed on the passivation layer 236 in the pixel region and is connected to the drain electrode 234 through the drain contact hole 236a.

A black matrix 242 is formed on an inner surface of the second substrate 240. The black matrix 242 has an opening corresponding to the pixel region and corresponds to the gate line, the data line and the thin film transistor T. A color filter layer 244 is formed on the black matrix 242 and on the inner surface of the second substrate 240 exposed through the opening of the black matrix 242. Although not shown in the figure, the color filter layer 244 includes red, green and blue color filters, each of which corresponds to one pixel region. The red, green and blue color filters are sequentially and repeatedly disposed along a horizontal direction of the display panel 220 parallel to the gate line. The same color filters are disposed along the vertical direction of the display panel 220 parallel to the data line. A transparent common electrode 246 is formed on the color filter layer 244.

Meanwhile, although not shown in the figure, an overcoat layer may be formed between the color filter layer 244 and the common electrode 246 to protect the color filter layer 244 and to flatten a surface of the second substrate 240 including the color filter layer 144.

The liquid crystal layer 248 is disposed between the pixel electrode 238 of the first substrate 222 and the common electrode 246 of the second substrate 240. Although not shown in the figure, alignment layers, which determine initial arrangements of liquid crystal molecules, are formed between the liquid crystal layer 248 and the pixel electrode 238 and between the liquid crystal layer 248 and the common electrode 246, respectively.

Even though, in this embodiment, the pixel electrode 238 and the common electrode 246 are formed on the first and second substrates 222 and 240, respectively, both the pixel electrode 238 and the common electrode 246 may be formed on the first substrate 222.

In the meantime, a first polarizer 252 is disposed on an outer surface of the first substrate 222, and a second polarizer 250 is disposed on an outer surface of the second substrate 240. The first and second polarizers 252 and 250 transmit linearly polarized light, which is parallel to their transmission axes. The transmission axis of the first polarizer 252 is perpendicular to the transmission axis of the second polarizer 250. Adhesive layers may be disposed between the first substrate 222 and the first polarizer 252 and between the second substrate 240 and the second polarizer 250.

Although not shown in the figure, a backlight unit is disposed under the first polarizer 252 to provide light to the display panel 220.

A lenticular lens film 270 is disposed on the second polarizer 250. The lenticular lens film 270 includes a base film 272 and lenticular lenses 274. Although not shown in the figure, the base film 272 may be attached to the second polarizer 250 with an adhesive layer.

The base film 272 of the lenticular lens film 270 may be formed of a material having zero birefringence or relatively low birefringence. Beneficially, the base film 272 may have the in-plane retardation value Rin within a range of −10 nm to +10 nm, more beneficially, of 0 nm, and the thickness retardation value Rth within a range of −50 nm to +50 nm. The base film 272 may include tri-acetyl cellulose (TAC), cyclo-olefin polymer (COP) or an acrylic material having zero retardation. For instance, TAC may have the in-plane retardation value Rin of 0 nm and the thickness retardation value Rth of −50 nm. The acrylic material having zero retardation may have the in-plane retardation value Rin of 0 nm and the retardation value Rth of 0 nm.

A lens pitch P_{L} of the lenticular lens film 270, which is defined as a width of each lenticular lens 274 or a distance between peaks of adjacent lenticular lenses 274, has a difference of about ±5 μm from a pixel pitch P_{P} of the display panel 220, which is defined as a distance from an upper end of a pixel to an upper end of a next pixel along a vertical direction of the display panel 220. Beneficially, the lens pitch P_{I}, is smaller than or equal to the pixel pitch P_{P}.

The lenticular lenses 274 are arranged along the vertical direction of the display panel 220.

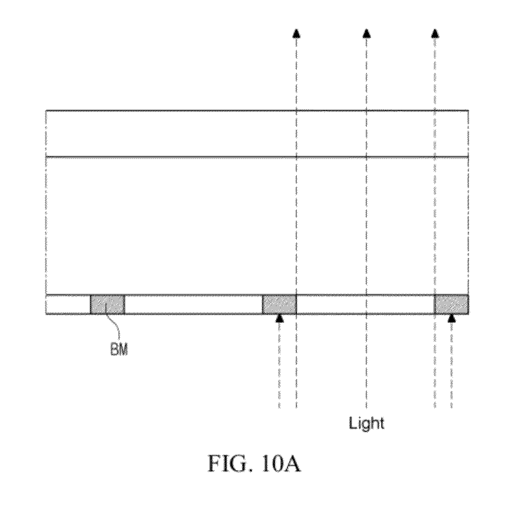

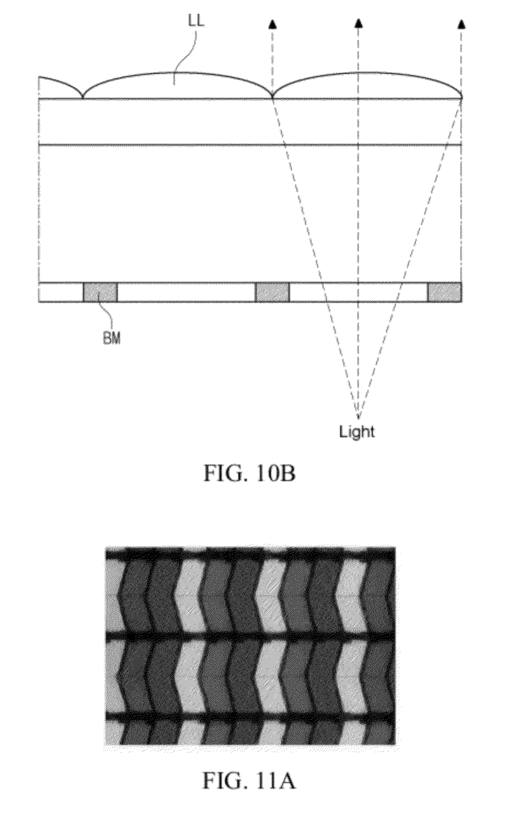

FIG. 10A and FIG. 10B are views of illustrating paths of light in a two-dimensional image display device before and after attaching lenticular lenses, respectively. FIG. 11A and FIG. 11B are pictures of a two-dimensional image display device before and after attaching lenticular lenses, respectively.

In FIG. 10A and FIG. 11A, before attaching the lenticular lenses, light emitted from the backlight is partially lost by the black matrix BM, and the brightness at the front is lowered. To increase the brightness, light emitted from the backlight is increased, or an optical film is used for compensation. In this case, the power consumption is increased, or the manufacturing costs are raised.

On the other hand, in FIG. 10B and FIG. 11A, after attaching the lenticular lenses, light emitted from the backlight is concentrated by the lenticular lenses LL. The brightness at the front is increased as compared with the device of FIG. 10A and FIG. 11B.

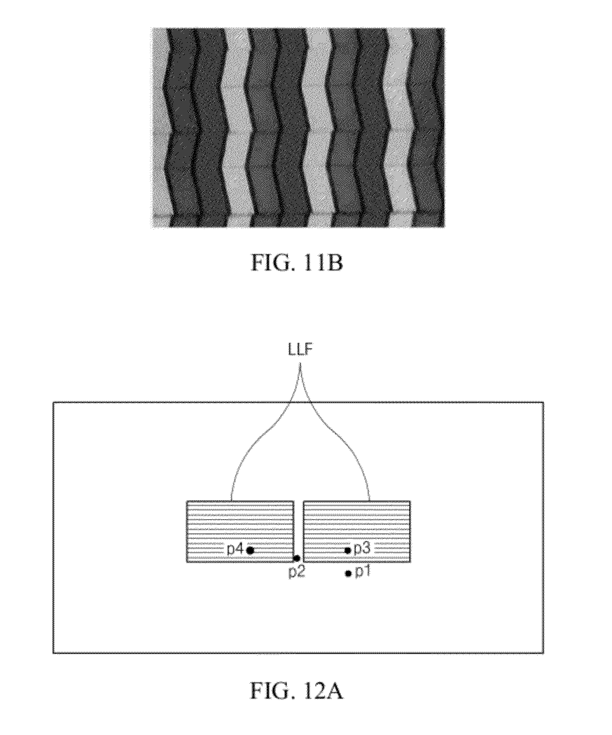

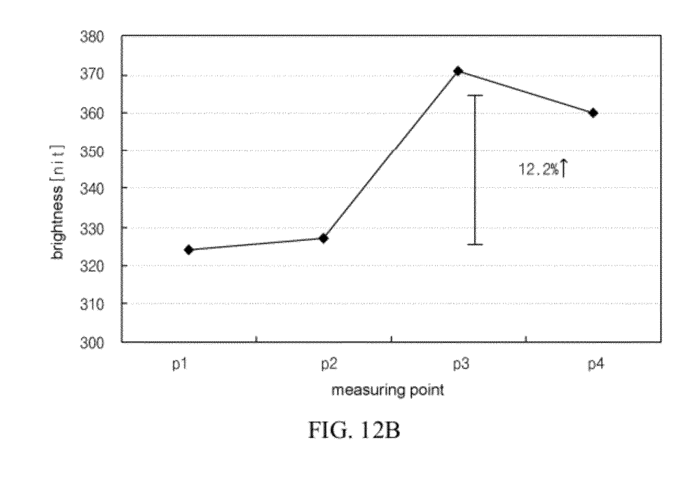

FIG. 12A is a schematic view of illustrating an image display device for measuring the brightness depending on the presence of lenticular lenses, and FIG. 12B is a graph of showing the brightness at each point of FIG. 12A.

In FIG. 12A, two lenticular lens films LLF are attached and spaced apart from each other in a central portion of the image display device. Brightness is measured at each of a first point p1 adjacent to the right lenticular lens film LLF, a second point p2 between the lenticular lens films LLF and at the center of the display device, and third and fourth points p3 and p4 corresponding to respectively lenticular lens films LLF.

As shown in FIG. 12B, the brightness at the first point p1 is 324.1 nit, the brightness at the second point p2 is 327.1 nit, the brightness at the third point p3 is 370.9 nit, and the brightness at the fourth point p4 is 359.7 nit.

Namely, the average brightness of the first and second points p1 and p2, at which the lenticular lens films are not attached, is 325.6 nit, and the average brightness of the third and fourth points p3 and p4, at which the lenticular lens films LLF are attached, is 365.3 nit. In case that the lenticular lens films LLF are attached, the brightness is increased by about 12.2%.

In addition, while the brightness generally is highest at the center of the display device, the brightness at the third and fourth points p3 and p4 at which the lenticular lens films LLF are attached is higher than the brightness at the second point p2 of the center at which the lenticular lens films LLF are not attached.

Therefore, the brightness at the front can be further improved by applying the lenticular lens film to a two-dimensional image display device.

In the three-dimensional image display device according to the present invention, the lenticular lens is disposed on the patterned retarder to concentrate light on a predetermined direction. Therefore, the 3D crosstalk is prevented, and the viewing angle properties are improved. In addition, the aperture ratio and the brightness are increased.

Moreover, the lenticular lens is disposed over the polarizer of a two-dimensional image display device, and light from the backlight is concentrated, thereby improving the brightness.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An image display device, comprising:
a display panel including a display area and a non-display area, wherein the display area includes left-eye horizontal pixel lines displaying a left-eye image and right-eye horizontal pixel lines displaying a right-eye image;
a polarizing film disposed over the display panel, wherein the polarizing film linearly polarizes the left-eye image and the right-eye image;
a patterned retarder disposed over the polarizing film and including left-eye retarders and right-eye retarders, wherein the left-eye retarders correspond to the left-eye horizontal pixel lines and change the linearly polarized left-eye image into left-circularly polarized image, and the right-eye retarders correspond to the right-eye horizontal pixel lines and change the linearly polarized image into right-circularly polarized image; and
a lenticular lens film disposed over the polarizing film and including lenticular lenses, wherein the lenticular lenses correspond to the left-eye retarders and the right-eye retarders, respectively.

2. The device according to claim 1, wherein the patterned retarder is disposed between the polarizing film and the lenticular lens film.

3. The device according to claim 1, wherein a lens pitch of the lenticular lens film has a difference of ±5 μm from a pixel pitch, which is a distance from an upper end of one of adjacent left- and right-eye horizontal pixel lines to an upper end of the other of the adjacent left- and right-eye horizontal pixel lines.

4. The device according to claim 1, wherein a focal length of the lenticular lenses is within a range of about 2000 μm to about 3000 μm.

5. The device according to claim 4, wherein a thickness of the lenticular lenses is within a range of about 20 μm to about 200 μm.

6. The device according to claim 1, wherein the lenticular lens film further includes a base film, which is adjacent to the patterned retarder and has a in-plane retardation value within a range of −10 nm to +10 nm and a thickness retardation value within a range of −50 nm to +50 nm.

7. The device according to claim 6, wherein the base film of the lenticular lens film includes one of tri-acetyl cellulose, cyclo-olefin polymer and an acrylic material having zero retardation.

8. The device according to claim 1, wherein the display panel further includes a black matrix corresponding to the non-display area.

9. The device according to claim 8, wherein the black matrix has a width of about 70 μm.

10. The device according to claim 8, wherein the display panel includes first and second substrate spaced apart from each other; a thin film transistor on the first substrate; a pixel electrode connected to the thin film transistor; a common electrode forming a capacitor with the pixel electrode; the black matrix on the second substrate and having an opening; and a color filter layer on the second substrate and corresponding to the opening.

11. An image display device, comprising:
a display panel including horizontal pixel lines, each of which comprises a plurality of pixels;
a linear polarizing film disposed over the display panel; and
a lenticular lens film disposed over the linear polarizing film and including lenticular lenses, wherein the lenticular lenses correspond to the horizontal pixel lines.

12. The device according to claim 11, wherein a lens pitch of the lenticular lens film has a difference of ±5 μm from a pixel pitch, which is a distance from an upper end of one horizontal pixel line to an upper end of a next horizontal pixel line.

13. The device according to claim 11, wherein the lenticular lens film further includes a base film, which is adjacent to the linear polarizing film and has a in-plane retardation value within a range of −10 nm to +10 nm and a thickness retardation value within a range of −50 nm to +50 nm.

14. The device according to claim 13, wherein the base film of the lenticular lens film includes one of tri-acetyl cellulose, cyclo-olefin polymer and an acrylic material having zero retardation.
